(19) United States
(12) Patent Application Publication
(10) Pub. No.: US 2024/0267695 A1
(43) Pub. Date: Aug. 8, 2024

(54) NEURAL RADIANCE FIELD SYSTEMS AND METHODS FOR SYNTHESIS OF AUDIO-VISUAL SCENES

(71) Applicant: University of Rochester, Rochester, NY (US)

(72) Inventors: Chenliang XU, Pittsford, NY (US); Susan Liang, Rochester, NY (US); Chao Huang, Rochester, NY (US); Yapeng Tian, Plano, TX (US); Fnu Anurag Kumar, Bothell, WA (US)

(21) Appl. No.: 18/431,491

(22) Filed: Feb. 2, 2024

Related U.S. Application Data
(60) Provisional application No. 63/443,258, filed on Feb. 3, 2023.

(51) Int. Cl. H04S 7/00; G06T 7/60; G06T 15/20; G06T 17/00; H04S 3/00

(52) U.S. Cl. CPC H04S 7/303; G06T 7/60; G06T 15/20; G06T 17/00; H04S 3/008; G06T 2207/20084; H04S 2400/01; H04S 2400/11

(57) ABSTRACT

An audio-visual scene synthesis system may include a visual neural network, a cross-model bridge, and an audio neural network. Parameters of the audio neural network may be generated by the cross-model bridge based on analysis of a 3-dimensional visual environment modeled by the visual neural network. A coordinate transformation module may apply a transformation to an input camera direction to synthesize a new camera direction. The audio neural network may utilize the new camera direction and the parameters of the audio neural network to synthesize a multi-channel audio signal corresponding to the new camera direction. Various other devices, systems, and methods are also disclosed.

### CROSS REFERENCE TO RELATED APPLICATIONS

This application claims the benefit of U.S. Provisional Application No. 63/443,258, filed Feb. 3, 2023, the disclosure of which is incorporated, in its entirety, by this reference.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1A shows example images input to a Neural Radiance Fields (NeRF) system for synthesizing novel views, in accordance with various embodiments.

FIG. 1B shows example images rendered by the NeRF system based on the input images illustrated in FIG. 1A, in accordance with various embodiments.

FIG. 2A shows example videos accompanied by audio that are input to an Audio-Visual NeRF (AV-NeRF) system for synthesizing novel views, in accordance with various embodiments.

FIG. 2B shows example audio-visual scenes rendered by the AV-NeRF system based on the input videos illustrated in FIG. 2A, in accordance with various embodiments.

FIG. 3 shows an example pipeline for rendering AV-NeRF scenes, in accordance with various embodiments.

FIG. 4A shows an example visual architecture for AV-NeRF scenes, in accordance with various embodiments.

FIG. 4B shows an example audio architecture for AV-NeRF scenes, in accordance with various embodiments.

FIG. 5A shows example recording devices for capturing audio-visual input for an AV-NeRF system, in accordance with various embodiments.

FIG. 5B shows example indoor scenes from a real-world location, in accordance with various embodiments.

FIG. 6 shows example indoor audio-visual scenes collected at different camera poses from a real-world location, in accordance with various embodiments.

FIG. 7 illustrates example audio-visual scenes rendered by an AV-NeRF system based on input images from different camera poses and input audio from a specific location, in accordance with various embodiments.

FIG. 8 illustrates example audio-visual scenes rendered by an AV-NeRF system based on input images from different camera poses and input audio from a specific location, in accordance with various embodiments.

FIG. 9 shows user study results comparing audio-visual scenes rendered by the disclosed AV-NeRF system versus scenes rendered using other techniques, in accordance with various embodiments.

FIG. 10 is a flow diagram of an exemplary audio-visual scene synthesis method, in accordance with embodiments of this disclosure.

FIG. 11 is an illustration of exemplary augmented-reality glasses that may be used in connection with embodiments of this disclosure.

FIG. 12 is an illustration of an exemplary virtual-reality headset that may be used in connection with embodiments of this disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within this disclosure.

### DETAILED DESCRIPTION OF EXAMPLE EMBODIMENTS

Human perception of the complex world primarily relies on a comprehensive analysis of multi-modal signals, and the co-occurrences of audio and video signals may provide humans with rich cues. Vision and sound play essential roles in human perception of the surrounding scene. These two modalities contain not only semantic information (e.g., the class of objects and the content of speech) but also spatial information (e.g., the position of sound sources). A human brain can analyze and integrate different modalities to thoroughly understand the surrounding environment. Naturally, the absence of either modality may hinder one's sense of the physical world. Recognizing this, the machine perception research community has seen a spectrum of works proposed to learn and model auditory and visual signals jointly.

Novel “audio-visual scene synthesis,” as used herein, generally refers to a task of synthesizing a target video, including visual frames and the corresponding spatial audio, along an arbitrary camera trajectory from given source videos and trajectories. Learning from source video in a real-world environment with binaural audio, the generated target spatial audio and video frames may be expected to be consistent with the given camera trajectory visually as well as acoustically to ensure perceptual realism and immersion.

Using a NeRF-based model for direct audio synthesis is typically insufficient due to the model's lack of prior knowledge and acoustic supervision. Conventional systems and methods for synthesizing audio-visual scenes have some constraints that may limit their usage in solving the above problems. For example, while neural acoustic fields may be used to model sound propagation in a room, such modeling may only work adequately in a simulation environment and may rely on ground-truth acoustic labels that are difficult to obtain in a real-world scene. Additionally, a manifold learning method can map latent vectors to image and audio pairs. However, such latent vectors may be uninterpretable and the manifold may not support controllable generation of audio-visual pairs.

The following description focuses on novel audio-visual scene synthesis in the real world. Given a video recording of an audio-visual scene, new videos may be synthesized with spatial audios along arbitrary novel camera trajectories in that audio-visual scene. An audio-visual scene synthesis system, as disclosed herein, may utilize an acoustic-aware audio generation module. The acoustic-aware audio generation module may integrate prior knowledge of audio propagation into NeRF, which associates audio generation with the 3D geometry of the visual environment. In addition, a coordinate transformation module that expresses a viewing direction relative to the sound source may be utilized. Such a direction transformation may help the model learn sound-source-centric acoustic fields. Moreover, a head-related impulse response function may be utilized to synthesize pseudo-binaural audio for data augmentation that strengthens training. The disclosed audio-visual scene synthesis system may provide qualitative and quantitative advantages in generating real-world audio-visual scenes in comparison to conventional model-based systems.

The disclosed audio-visual scene synthesis system is capable of generating real-world audio-visual scenes along a novel camera trajectory that has no spatial overlap with the source camera trajectories used for training. The system includes a visual neural network configured to receive the input camera trajectory and generate a sequence of visual frames and an audio neural network configured to receive the same input camera trajectory and synthesize a sequence of two-channel audio. The system includes a “cross-model bridge” neural network configured to analyze the 3D environment modeled by the visual neural network and generate the parameters of the audio neural network. The system additionally includes a “coordinate transformation” module that receives the input camera pose, applies a transformation to the camera direction, and generates the new camera direction that is expressed relative to the sound source. Since the disclosed system can generate auditory and visual signals, it may help people who have either vision or hearing impairment gain a clearer perception of the physical world. It may also enhance perceptual realism and immersion for people without such perception loss.

Features from any of the embodiments described herein may be used in combination with one another in accordance with the general principles described herein. These and other embodiments, features, and advantages will be more fully understood upon reading the following detailed description in conjunction with the accompanying drawings and claims.

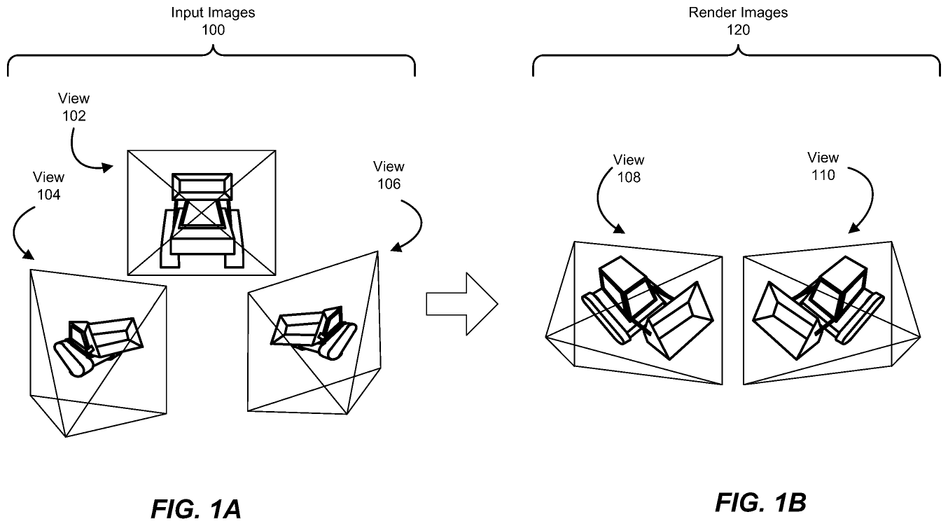

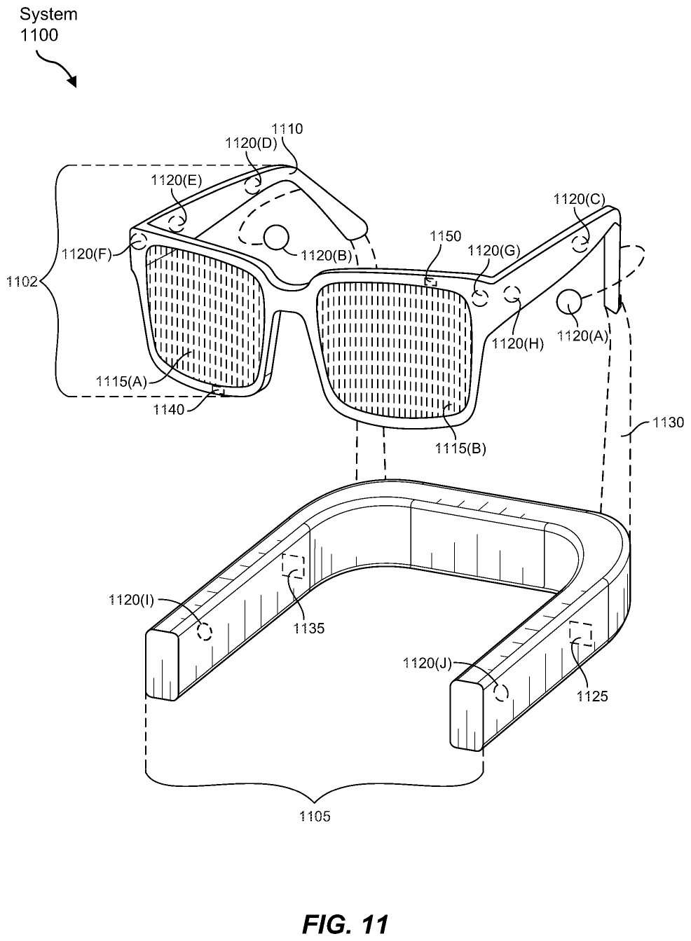

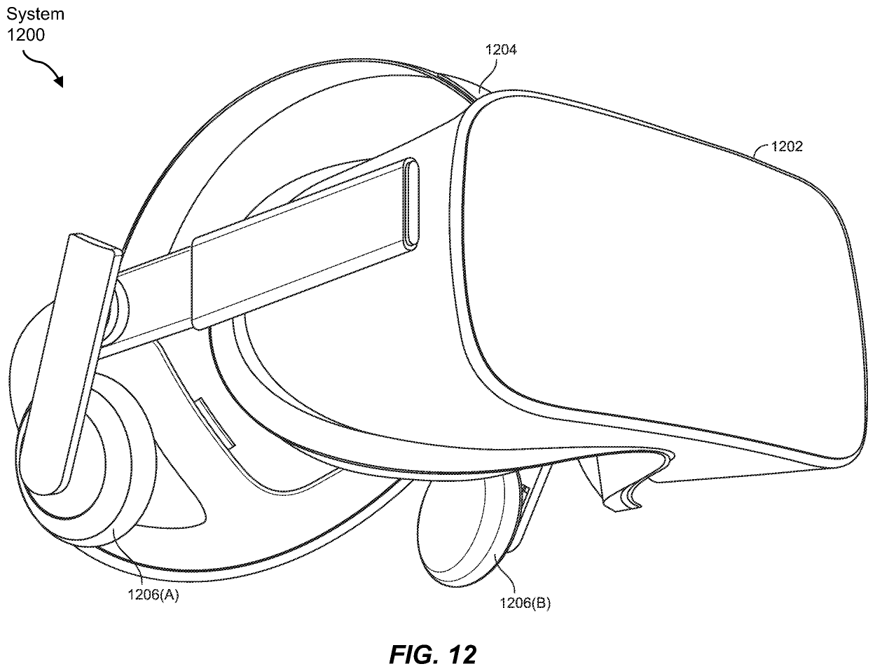

The following will provide, with reference to FIGS. 1A-12, a detailed description of audio-visual scene synthesis systems, apparatuses, and methods. The discussion associated with FIGS. 1A-10 relates to the architecture and operation of various audio-visual scene synthesis systems. The discussion associated with FIGS. 11 and 12 relates to exemplary virtual reality and augmented reality devices that may include audio-visual scene synthesis systems as disclosed herein.

The present disclosure describes a novel NeRF-based method for synthesizing real-world audio-visual scenes (i.e., “AV-NeRF”). NeRF implicitly and continuously represents the visual scene using neural fields and the neural fields can be used to render novel views, as illustrated in FIGS. 1A and 1B. FIG. 1A depicts a set of input images from views 102, 104, and 106. In one example, NeRF may receive views 102, 104, and/or 106 and render views 108 and/or 110 as shown in FIG. 1B. Although NeRF has achieved impressive success in the vision domain, directly using NeRF in disclosed tasks does not yield the best performance because of the lack of prior knowledge and acoustic supervision. NeRF uses a classical volume rendering method to render the color of a ray based on the physical property of light propagation. However, there is no prior knowledge for NeRF-based audio synthesis. Moreover, the recording mechanisms of these two signals are different. In particular, at a given camera pose, while an image with millions of pixels may be captured, only one acoustic signal may be simultaneously captured (assuming the acoustic property of the environment is time-invariant). Each pixel can serve as visual supervision while the whole acoustic signal may serve as auditory supervision. The imbalance between the amounts of visual data and audio data thus hinder the optimization of NeRF for audio synthesis. To tackle these challenges, an acoustic-aware audio generation module may incorporate prior knowledge of audio propagation into NeRF, a coordinate transformation mechanism that encourages NeRF-learning sound-source-centric neural fields, and/or a binaural audio augmentation method to improve acoustic supervision. To this end, the described AV-NeRF may be capable of generating audio-visual consistent scenes using approximately the same amount of data as conventional NeRF systems.

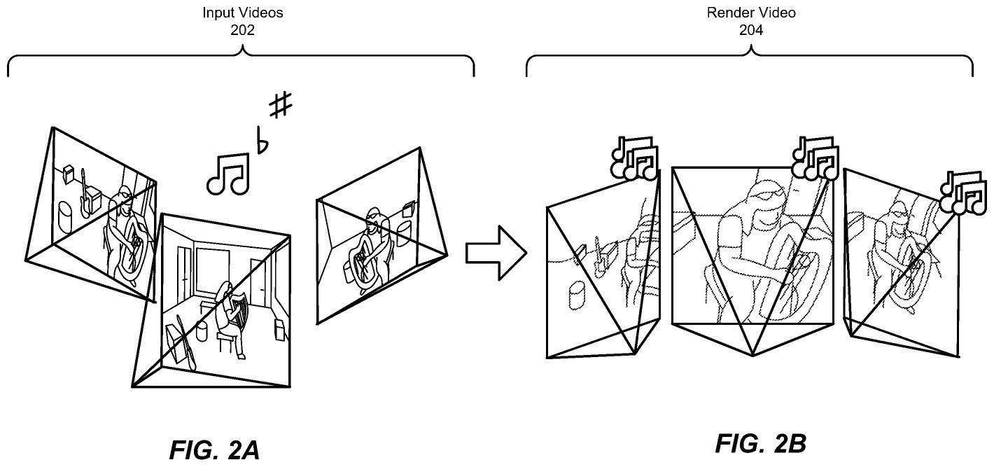

Considering that 3D geometry and material property of an environment determine the sound propagation (e.g., the existence of a barrier between the sound source and the sound receiver indicates the decay of sound energy), the present disclosure describes an acoustic-aware audio generation module (i.e., “AV-Bridge”) that correlates the spatial effects of the sound with the 3D visual geometry, as illustrated in FIGS. 2A and 2B. In one example, AV-NerF may receive input videos 202 illustrated in FIG. 2A and, using the processes described in greater detail below, render video 204 with binaural audio as illustrated in FIG. 2B. Visual NeRF can generate not only the color c of one point in 3D space but also its density σ. The density function of an environment serves as an important indicator of 3D geometry. The disclosed AV-Bridge extracts density information from the visual NeRF to obtain a voxel grid and learns its latent representation. This latent representation is fed into an audio NeRF and audio NeRF learning acoustic-aware audio generation is performed.

In conventional NeRF, viewing direction (ϑ, ϕ) is expressed in an absolute coordinate system. This coordinate expression is a natural practice in visual space such that the same orientation at different spatial positions is expressed equally. However, this expression method in audio space is sub-optimal. Human perception of the sound direction is based on the relative direction to the sound source instead of the absolute direction. For example, when a person walks around an omnidirectional sound source and keeps facing the sound source, their sensation of the sound source position is constant but their absolute orientation varies. Considering this fact, a coordinate transform mechanism may be utilized to express the viewing direction relative to the sound source so as to encourage the model to learn a sound-source-centric acoustic field.

Unlike simulation environments where the ground-truth acoustic information is easily accessible, samples in real-world scenes are captured sparsely and often cannot cover the whole environment. To render a realistic video at novel poses, a head-related impulse response function (HRIR) may be utilized to augment training data. HRIR serves as a sound filter that represents changes in sound with respect to the position of the sound source. This augmentation strategy can improve acoustic supervision and enhance the spatial effects of rendered audio at novel poses.

In summary, contributions of the presently-disclosed system may include (1) proposing a novel method of synthesizing real-world audio-visual scenes at novel positions and directions, (2) introducing a novel acoustic-aware audio generation method to encode NeRF's prior knowledge of sound propagation, (3) proposing a coordinate transformation mechanism for effective direction expression, (4) introducing a binaural audio augmentation method to improve the acoustic supervision, and/or (5) quantitatively and qualitatively demonstrating advantages of this method. The present disclosure targets modeling acoustic fields and establishing the correlation between visual and acoustic worlds.

The disclosed method is based on neural fields, especially Neural Radiance Fields (NeRF). NeRF may learn an implicit and continuous representation of visual scenes using a neural network and synthesize novel views based on the trained neural network. After the presence of NeRF, several works extend NeRF to broader domains, such as video (silent video), audio, and audio-visual. In some examples, neural acoustic fields (NAFs) may be used to capture how sound propagates in an environment. Although NAF achieves convincing results, its reliance on synthetic environments and ground truth impulse response functions hinder its application in real-world scenes. The discretization of position and direction (the listener can only move in a fixed x-y grid and rotate 0°, 90°, 180°, and 270°) may restrict the camera motion. In contrast, the disclosed model can handle continuous position and direction input.

In at least one conventional example, a manifold learning method that maps vectors in latent space to audio and image space may be utilized. While the learned manifold can be used for audio-visual interpolation, the model does not support controllable audio-visual generation because the latent space does not contain interpretable spatial and temporal information. The disclosed method instead learns implicit neural representations that are explicitly conditioned on spatial coordinates enabling controllable real-world scene generation.

Spatial audio cannot only help people localize a sound source but also establish an immersive experience in 3D environments. Recently, certain visually informed audio spatialization approaches have been proposed. Among them, at least one approach focuses on normal field-of-view video and binaural audio. An additional approach proposes a unified framework to solve the sound separation and stereo sound generation at the same time. At least one approach proposes a pseudo-binaural pipeline that correlates spatial locations with binaural audio people receive using HRIR function. Although these methods generate good binaural audio, they assume the ground-truth visual frames are available, which does not hold when the model generates audio at a novel pose. In contrast to conventional methods, embodiments disclosed herein do not rely on ground-truth images for audio spatialization because AV-NeRF learns an acoustic field that is only conditioned on the pose. Moreover, the disclosed model uses two orders of magnitude less data for training than other methods.

Another line of work focuses on acoustic simulation by modeling an environment's 3D geometry and material property. For example, an audio platform can calculate a room impulse response function of given discrete listener and sound source positions by modeling the geometry and material property of an environment. Extending the work, another system further utilizes an audio platform that supports realistic acoustic generation for arbitrary sounds captured from arbitrary microphone locations in 3D environments. Additionally, an early reverberation part modeled by geometric acoustic simulation and frequency modulation may be blended with a late reverberation tail extracted from recorded impulse response. Reverberation time (T₆₀) and equalization (EQ) may be estimated using a learning-based acoustic analysis method. The predicted T₆₀ and EQ may then be used for material optimization enabling audio rendering. Unlike these virtual rendering approaches, the presently-disclosed method learns from and synthesizes real-world audio-visual scenes conditioned on the learned 3D geometry of an environment.

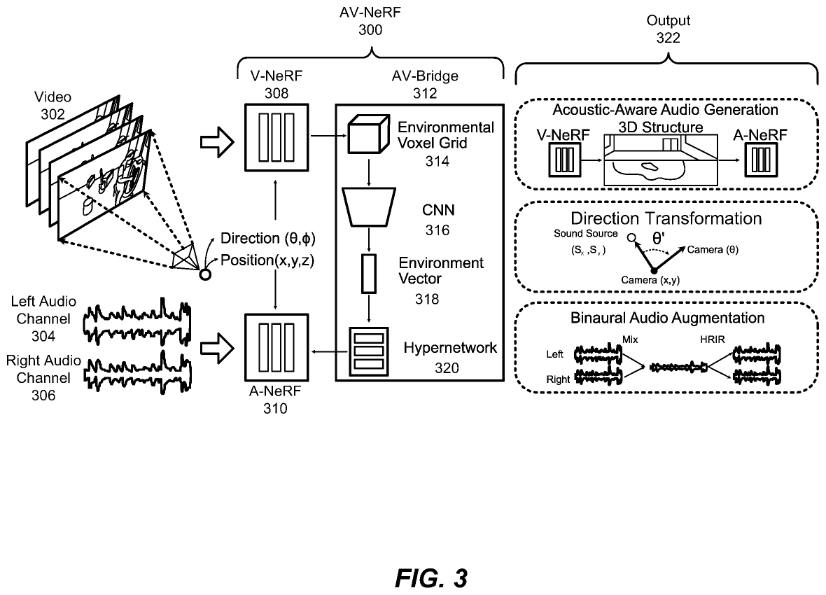

The disclosed systems and methods learn neural fields for synthesizing real-world audio-visual scenes at novel poses. When training AV-NeRF, the model may be fed with several video clips (with binaural audio) and corresponding camera trajectories when capturing these video clips. AV-NeRF may be encouraged to learn a mapping from camera trajectories to video clips. At inference time, AV-NeRF may be fed with an arbitrary camera trajectory and the model may be expected to output a target video that is consistent with the input camera trajectory visually and acoustically. The pipeline is illustrated in FIG. 3. As illustrated in FIG. 3, the disclosed model may include three trainable modules: V-NeRF 308, A-NeRF 310, and AV-Bridge 312. A-NeRF 310 may learn to generate acoustic masks, V-NeRF 308 may learn to generate visual frames, and AV-Bridge 312 may be optimized to extract geometric information from V-NeRF 308 and integrate this information into A-NeRF 310. In one example, AV-NeRF 300 may receive a video 302 that includes a left audio channel 304 and a right audio channel 306. In this example, V-NeRF 308 may process video 302 while A-NeRF 310 processes left audio channel 304 and right audio channel 306, both in communication with AV-Bridge 312. In some embodiments, AV-Bridge 312 may include an environment voxel grid 314, convolutional neural network (CNN) 316, environment vector 318, and/or hypernetwork 320. In one example, this may result in output 322 that includes features such as acoustic-aware audio generation, direction transformation (e.g., of a camera angle), and/or binaural audio augmentation.

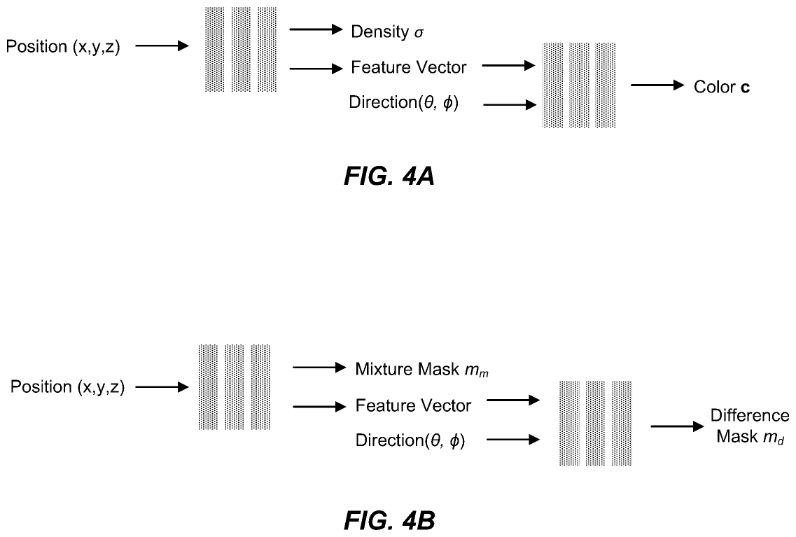

NeRF uses a Multi-Layer Perceptron (MLP) to represent a visual scene implicitly and continuously. It learns a mapping from camera poses to colors and densities:

$$N eRF : ( x , y , z , θ , ϕ ) \to ( c , σ ) , \qquad ( Eq . 1 )$$

where X=(x, y, z) is the 3D position, d=(ϑ, ϕ) is the direction, c=(r, g, b) is the color, and σ is the density. To render view-dependent color c and ensure multiview consistency, NeRF first maps a 3D coordinate (x, y, z) (we apply positional encoding to all input coordinates, unless otherwise noted) to density σ and a feature vector; then NeRF maps the feature vector and 2D direction (ϑ, ϕ) to a color c. This process is illustrated in FIG. 4A.

NeRF then uses the volume rendering method to generate the color of any ray r(t)=o+td marching through the visual scene with near and far bounds tₙ and t_{f}:

$$C ( r ) = {\int }_{{t}_{n}}^{{t}_{f}} T ( t ) ( r ( t ) ) c ( r ( t ) , d ) dt , \qquad ( Eq . 2 )$$

where T(t)=exp(−∫ₜ_{ₙ}^{t}(r(s))ds) and d=(ϑ, ϕ) (expressed as a 3D Cartesian unit vector). This continuous integral is estimated by quadrature in practice. Considering that the model learns a neural representation of real-world scenes, the systems described herein may not apply normalized device coordinate (NDC) transformation to 3D coordinates.

The target of A-NeRF is to learn a neural acoustic representation that can map 5D coordinates (x, y, z, ϑ, ϕ) to corresponding acoustic masks mₘᵥm_{d}∈R^{2×F}, where mₘ means the change of magnitude and phase of sound with regard to the position (x, y, z), while m_{d} means the change of magnitude and phase of sound with regard to the direction (ϑ, ϕ), and F is the number of frequency bins:

$$N eRF : ( x , y , z , θ , ϕ ) \to ( {m}_{m} , {m}_{d} ) \qquad ( Eq . 3 )$$

In practice, as shown in FIG. 4B, the systems described herein feed A-NeRF with 3D position (x, y, z) to obtain a mixture mask mₘ and a feature vector. Then the systems described herein concatenate this feature vector with the input direction (ϑ, ϕ) and pass it to the rest part of A-NeRF to generate a difference mask m_{d}.

For the sake of clarity, the systems described herein use â to represent predicted audio and a to represent ground-truth audio in the rest of paper. Given a sound aₛ, the systems described herein first utilize short-time Fourier transform (STFT) to convert input audio from the time domain to the time-frequency domain STFT(aₛ)=sₛ∈R^{2×F×W}, where W is the number of time frames. Then, the systems described herein multiply sₛ and mₘ using complex multiplication to predict the spectrum of the mix sound ŝₘ∈R^{2×F×W} at target position (x, y, z). To enable binaural audio generation, the systems described herein further multiply the predicted spectrum ŝₘ and m_{d} to calculate the difference between left and right channels ŝ_{d}∈R^{2×F×W}. Finally, the systems described herein use inverse short-time Fourier transform (ISTFT) to generate binaural audio âₗ, âᵣ, the systems described herein define âₘ=âₗ+âᵣ and â_{d}=âₗ-âᵣ, so (âₘ+â_{d})/2=(âₗ+âᵣ+âₗ-âᵣ)/2=âₗ and (âₘ-â_{d})/2=(âₗ+âᵣ-âₗ+âᵣ)/2=âᵣ. This process can be formulated mathematically in Eq. 4. Instead of estimating the left and right channels of the target audio directly, the systems described herein predict the mix of target audio âₘ and the difference between two channels of the target audio â_{d}. directly predicting two channels may make audio spatialization network learn some shortcuts.

$$\begin{matrix}{â}_{m} = ISTFT ( {\hat{s}}_{m} ) \\ = ISTFT ( {s}_{s} * {m}_{m} ) , \\ {â}_{d} = ISTFT ( {\hat{s}}_{d} ) \\ = ISTFT ( {\hat{s}}_{m} * {m}_{d} ) \\ = ISTFT ( {s}_{s} * {m}_{m} * {m}_{d} ) , \\ {â}_{l} = ( {â}_{m} + {â}_{d} ) / 2 , \\ {â}_{r} = ( {â}_{m} - {â}_{d} ) / 2.\end{matrix} \qquad ( Eq . 4 )$$

Given the fact that 3D geometry and material property determine the sound propagation in an environment, an acoustic geometry-aware audio generation method may be used by integrating 3D visual geometry information learned by V-NeRF with A-NeRF. When V-NeRF learns to represent visual scenes, thanks to the multiview consistency constraint, it can capture the density function σ of the environment. Such density function represents the existence of objects within the environment. So, geometric information may be extracted from V-NeRF and it may be encoded into a feature vector for acoustic-aware audio generation.

Specifically, V-NeRF may be queried with discrete 3D points that are uniformly scattered in the environment. The output volume density may be composed into an environment voxel grid, which represents the 3D structure of the scene. A convolutional neural network may then be used to encode this voxel grid into a compact environment vector. After obtaining the environment vector, a Hypernetwork may utilize this geometric information for acoustic-aware audio generation. A Hypernetwork ψ may be designed to convert the environment vector v into parameters W_{A} of A-NeRF inspired by:

$$ψ : v \to {W}_{A} \qquad ( Eq . 5 )$$

For each learnable linear layer Wᵢ ∈R^{m×n} in A-NeRF, the systems described herein may train a three-layer MLP to output a weight matrix M of the same shape as Wᵢ. The input of each MLP is the environment vector v. The matrix M is fused with the parameters Wᵢ to generate new parameters for guiding audio generation:

$${W}_{i} ← {W}_{i} ⊙ M , \qquad ( Eq . 6 )$$

where ⊙ is Hadamard product. Directly predicting high-dimensional matrix M is not only computation-consuming but also difficult to optimize. So the high-dimensional matrix M∈R^{m×n} may be decomposed into two low-dimensional matrices A∈R^{m×k} and B∈R^{k×n}, where k<m and k<n, and express matrix M as M=σ(A×B). MLP may be optimized to generate these two low-dimensional matrices instead of the original matrix.

Viewing direction (ϑ, ϕ) in V-NeRF is expressed in an absolute coordinate system. This is a natural practice in visual space such that the same orientation at different spatial positions is expressed equally. As discussed in the introduction, however, this expression method in audio space is sub-optimal because the human perception of the sound direction is based on the relative direction to the sound source instead of the absolute direction. To overcome this shortage, viewing direction may be expressed relative to the sound source. This coordinate transformation encourages A-NeRF learning a sound-source-centric acoustic field.

Given the 3D position of the sound source Xₛ=(xs, ys, zs) and camera pose (X, d)=(x, y, z, ϑ, ϕ), two direction vectors are obtained: V₁=Xₛ−X=(xₛ−x, yₛ−y, zₛ−z) and V₂=(sin(ϑ) cos(ϕ), sin(ϑ) sin(ϕ), cos(ϑ)). The angle between V₁ and V₂ is calculated as the relative direction coordinates ∠(V₁, V₂). This angle ∠(V₁, V₂) represents the rotation angle relative to the sound source. With this coordinate transformation, different camera poses can share the same view direction encoding if they face the sound source at the same angle. This angle may be expressed as a 2D Cartesian unit vector when feeding it to A-NeRF.

Capturing high-quality binaural audio may require a professional recording system such as a binaural microphone and dummy head that mimics the sound people can hear. This requirement may restrict the application of the disclosed method in videos captured by conventional commodity devices (e.g., smartphones, head-mounted cameras, etc.). Although several commodity devices support recording stereo sound, the microphone arrangement may be arbitrary and may not imitate the sound effects caused by human heads. Accordingly, head-related impulse response (HRIR) may be applied to stereo audio to generate binaural audio with rich spatial information. HRIR is a response function that characterizes the influence of the human head and sound position on sound propagation. An open-sourced HRIR database may be exploited for binaural audio augmentation. Specifically, a pair of HRIR functions hₗ and hᵣ of a given angle may be retrieved from the database and hₗ and hᵣ may be convolved with the mixed ground-truth stereo audio (aₗ+a_{f})/2 to generate a binaural audio (Eq. 7). Please note that the mix of audio for data augmentation is different from that for modeling training. The mix of two channels may be divided by 2 to get the average signal for data augmentation.

$${a}_{l} ← {h}_{l} ( {a}_{l} + {a}_{r} ) / 2 , \qquad ( Eq . 7 )$$

$${a}_{r} ← {h}_{r} ( {a}_{l} + {a}_{r} ) / 2 ,$$

where [symbol] is the convolution operator. By augmenting training audio, the systems described herein encourage the model to correlate acoustic effects with the position of the sound source.

The combination of V-NeRF and A-NeRF may be referred to as the baseline method. The AV-Bridge, coordinate transformation module, and data augmentation mechanism may be integrated into the baseline method to assemble the AV-NeRF model. Because AV-Bridge may be optimized together with A-NeRF and the coordinate transformation module and data augmentation mechanism do not contain learnable parameters, the baseline method and AV-NeRF are optimized using the same learning objective. The loss function of V-NeRF is:

$${L}_{V} = {‖ C ( r ) - \hat{C} ( r ) ‖}^{∧} 2 , \qquad ( Eq . 8 )$$

where C(r) is the ground-truth color along the ray r and Ĉ(r) is the color rendered by V-NeRF.

The L2 loss function may be used to supervise A-NeRF. Given a mono source audio aₛ and a binaural target audio aₜ, the mix audio aₘ=aₜ₍ₗ₎+aₜ₍ᵣ₎, the difference audio a_{d}=aₜ₍ₗ₎−aₜ₍ᵣ₎, and spectrums of 0, aₘ, and a_{d}, which are sₛ, sₘ, and s_{d}, may be respectively calculated. Then the distance between calculated spectrums and predicted spectrums may be minimized:

$${L}_{A} = {‖ {s}_{m} - {\hat{s}}_{m} ‖}^{2} + {‖ {s}_{d} - {\hat{s}}_{d} ‖}^{2} , \qquad ( Eq . 9 )$$

$$= {‖ {s}_{m} - {s}_{s} * {m}_{m} ‖}^{2} + {‖ {s}_{d} - {s}_{s} * {m}_{m} * {m}_{d} ‖}^{2} .$$

The first term of LA encourages A-NeRF predicting masks that represent spatial effects caused by distance, and the second term encourages A-NeRF generating masks that capture the difference between two channels.

In comparison to conventional methods, the method disclosed herein may synthesize real-world videos with perceptually spatial binaural audio at arbitrary poses. The present method may be validated on two representative real-world indoor scenes. Since the disclosed model can generate binaural audio, the AV-NeRF may be trained on a FAIR-PLAY dataset for objective comparisons.

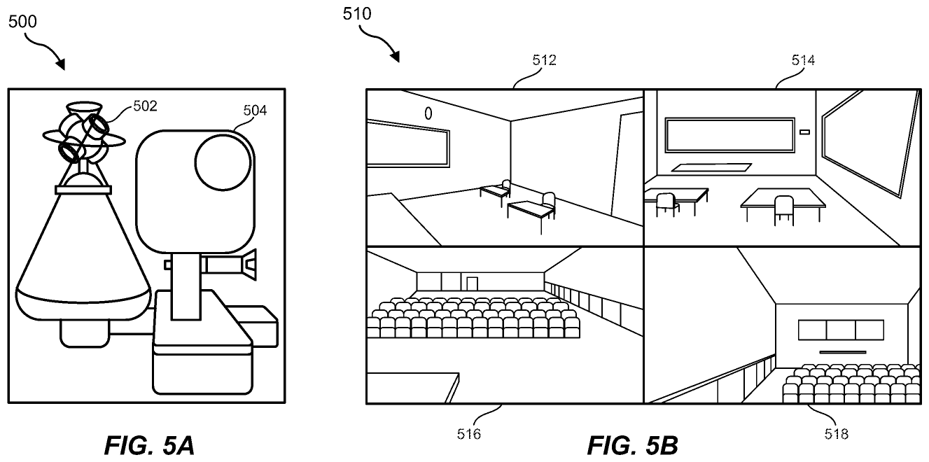

In one example, as illustrated in FIGS. 5A and 5B, two representative indoor scenes were collected in rooms of different sizes via specialized equipment. A medium room was 7×7 m² (23×23 ft²) and a large room was 40×20 m² (130×64 ft²). As shown in FIG. 5A, a recording system 500 included a microphone 502 (ZOOM H3-VR AMBISONIC) mounted to a camera 504 (GOPRO MAX). Microphone 502 includes, for example, a plurality of mics arranged in an Ambisonic array to capture full-sphere surround sound audio from the environment. Audio was recorded as binaural audio at 48 kHz. Video was captured by camera 504 at 30 fps in linear field of view mode to prevent image distortion. Recording system 500 was moved around in the environment to record both auditory and visual signals at different positions and from different viewing directions. FIG. 5B illustrates representative scenes 510 captured by recording system 500. A loudspeaker playing music was used as a sound source. For each scene, 2 minutes of data was collected. Scenes 512 and 514 illustrate scenes captured from the the medium room and scenes 516 and 518 illustrate scenes captured from the large room.

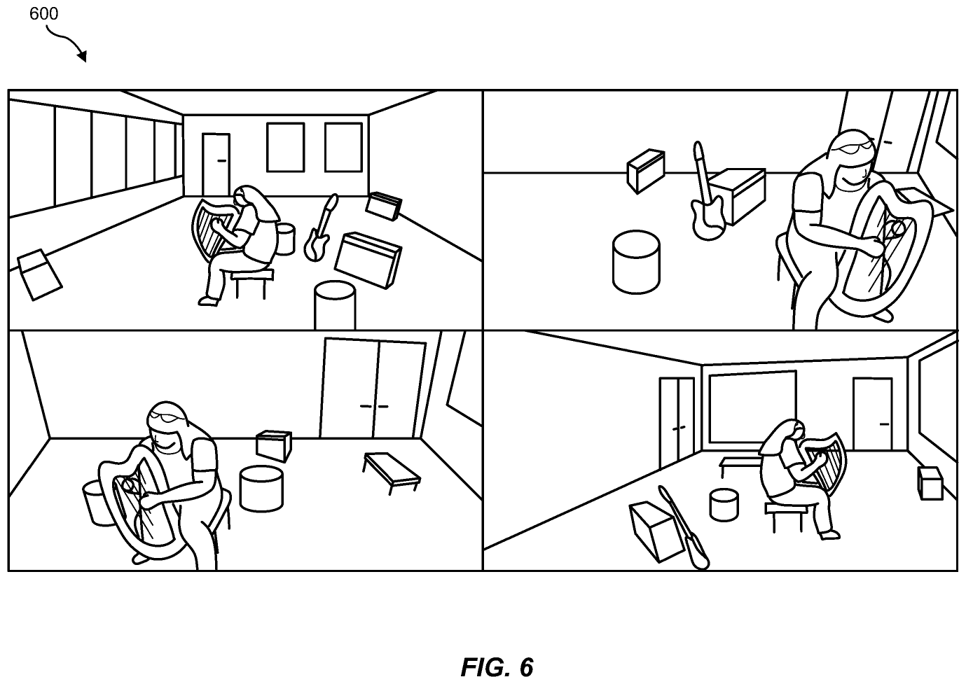

A publicly-available dataset (FAIR-PLAY Dataset from 2.5D Visual Sound, arXiv:1812.04204) was collected in a music room, the dataset including 1,871 video clips (each 10 s in length) of people playing instruments. Each video was accompanied by binaural audio recorded by a professional binaural microphone. This dataset was reorganized by selecting video clips that belong to the same scene. Such video clips can capture people playing instruments at different camera poses, which provides the model with rich spatial information. FIG. 6 shows an example scene composed of several video clips capturing a person playing the harp. As illustrated in FIG. 6, four representative scenes 600 were collected from the FAIR-PLAY dataset for training and evaluation (i.e., harp, cello, drum, and guitar). Solo videos were utilized and “split1” provided by FAIR-PLAY authors was used to split training and test samples.

A-NeRF and V-NeRF were instantiated as Multilayer Perceptron (MLP). A-NeRF has 6 fully-connected layers with 256 neurons per layer. V-NeRF has 8 fully-connected layers with 256 neurons per layer. Given a 3D environment voxel grid, a convolutional neural network (CNN) was used to extract geometric information. CNN has four 2D convolution layers with ReLU activations and 2D max pooling layers between two consecutive layers. Hypernetwork is a stack of 3-layer MLPs. For each fully-connected layer of A-NeRF, a 3-layer MLP was used to generate a low-rank matrix M.

Given an audio-visual scene (e.g., several video clips), V-NeRF was first trained to learn the visual world. Visual frames were extracted from input videos and COLMAP structure-from-motion library was used to estimate the intrinsic and extrinsic of the camera. The initial learning rate was set as 1e-3 and V-NeRF was optimized for 200K iterations. For easy optimization, only one NeRF model was used instead of a pair of coarse and fine models. After training V-NeRF, the parameters of V-NeRF were frozen and the rest of the framework was trained. 0.63 s audio clips were randomly sampled from videos and average poses of each clip. The batch size was set as 8, the learning rate was set as 1e-3, and A-NeRF was trained for 50K iterations. Binaural audio augmentation was applied to real-world indoor scenes but did not use it on the FAIR-PLAY dataset because an open-sourced head-related impulse response function was inconsistent with the head model of the recording system.

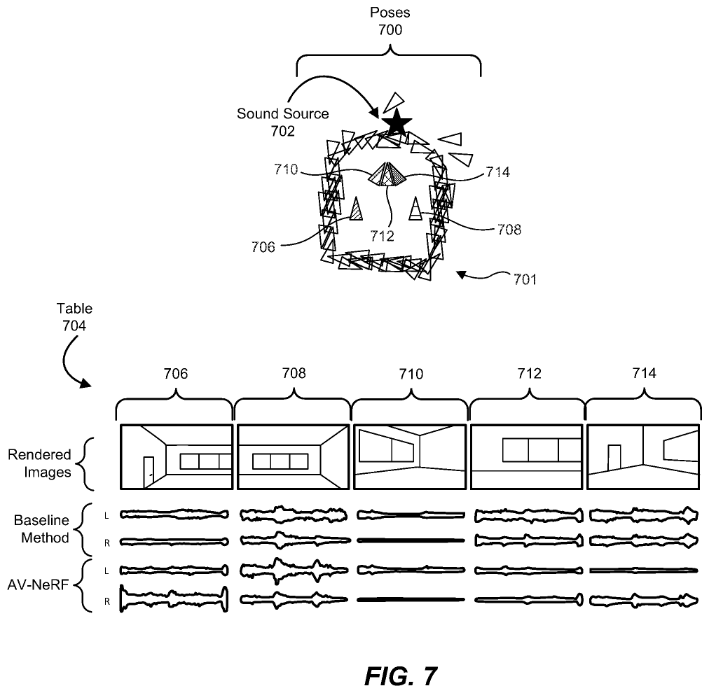

The method was validated qualitatively on real-world audio-visual scenes. A-NeRF and V-NeRF were composed as a baseline, which does not contain AV-Bridge, coordinate transformation, or binaural audio augmentation. FIG. 7 shows the rendering results of the large room (see scenes 516 and 518 in FIG. 5B) from a number of camera poses 700 captured at various positions around a sound source 702. As shown, the camera was rotated and moved through representative camera poses 706, 708, 710, 712, and 714. Poses 700 used for training and novel view synthesis are illustrated from a bird's eye view. In the illustration of poses 700, the direction of a triangle's sharp angle is the camera's orientation and the position of the triangle's sharp angle is the camera's position. Outer triangles 701 represent camera poses of training samples. Other triangles represent camera poses 706-714 used for novel audio-visual scene synthesis. There is no spatial overlap between training poses and novel poses.

Audio and visual rendering results are shown at different camera poses 706-714 in table 704. The first row in table 704 is the rendered image. The second and third rows in table 704 are binaural audio rendered by the baseline method. The fourth and fifth rows in table 704 show binaural audio rendered by AV-NeRF, as disclosed herein. AV-NeRF can render binaural audio with rich spatial information compared to the baseline method. When the sound source is on the right side of the camera view (camera pose 706 and 714), AV-NeRF can generate two channels with a distinct difference—the amplitude of the right channel is clearly larger than that of the left channel. When the sound source is on the left side of the camera view (camera pose 708 and 710), the amplitude of the left channel is clearly larger than that of the right channel. AV-NeRF can also generate balanced binaural audio when the camera faces the sound source directly.

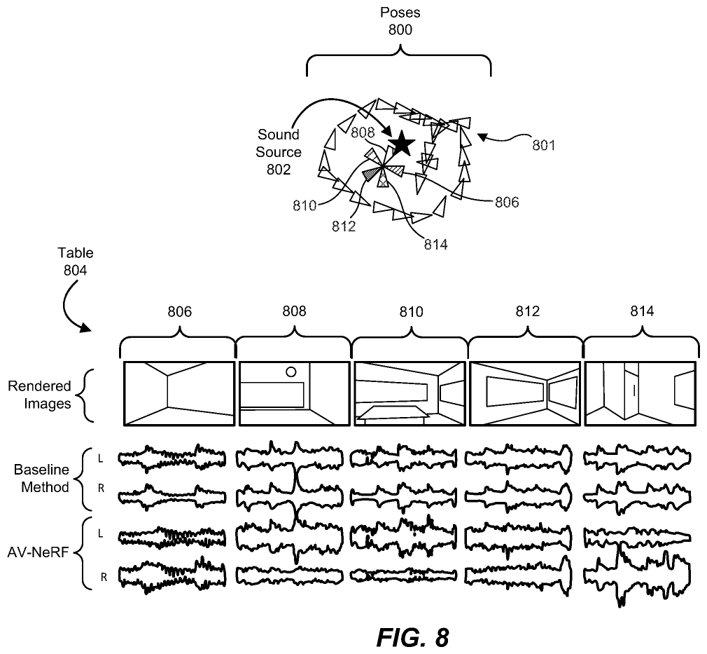

FIG. 8 shows the rendering results of the medium room (see scenes 512 and 514 in FIG. 5B) from a number of camera poses 800 captured at various positions around a sound source 802. The camera may be rotated to generate novel 360-degree audio-visual scenes and the camera position may be fixed when the camera orientation is changed. As shown, the camera was rotated and moved through representative camera poses 806, 808, 810, 812, and 814. Poses 800 used for training and novel view synthesis are illustrated from a bird's eye view. As shown in the figure, the disclosed AV-NeRF can render binaural audio consistent with the camera orientations. As shown in table 804, when the camera is rotated gradually from pose 806 through poses 808, 810, 812, and 814, the amplitude ratio (energy ratio) of the left channel to the right channel will first increase (from pose 806 to pose 810) and then decrease (from pose 810 to pose 814).

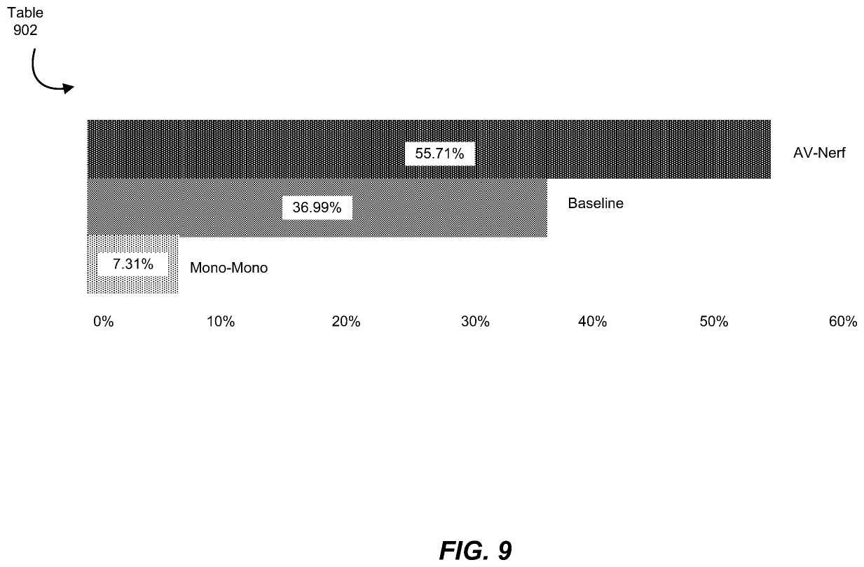

User studies were also conducted to validate the fidelity of the generated audio-visual scenes. For each room, 4 audio-visual scenes were generated with different camera motion trajectories. Scenes generated by AV-NeRF were compared with those generated by the baseline. A Mono-Mono method that directly copies an input mono audio twice to generate fake binaural audio was also included. A total of 22 participants with normal hearing were recruited. The participants were asked to watch videos generated by three methods and select the video with spatial consistency between rendered audio and video. Considering different methods may achieve comparable performance, the participants were asked to select multiple options. As shown in table 902 in FIG. 9, the disclosed AV-NeRF method received the most preference and exhibited a distinct advantage over other methods.

For numerical comparisons, the presently-disclosed AV-NeRF method was evaluated on a FAIR-PLAY dataset. Two metrics were used to evaluate the audio generation quality of a model: STFT distance and envelope (ENV) distance.

TABLE 1
Comparison of AV-NeRF with other methods of binaural audio generation.

| | Harp | | Cello | | Drum | | Guitar | | Overall | |
|---|---|---|---|---|---|---|---|---|---|---|
| Methods | STFT | ENV | STFT | ENV | STFT | ENV | STFT | ENV | STFT | ENV |
| M2B w/GT image | 0.551 | 0.119 | 0.630 | 0.131 | 0.103 | 0.048 | 0.839 | 0.142 | 0.531 | 0.110 |
| P2B w/GT image | 0.498 | 0.118 | 0.819 | 0.140 | 0.093 | 0.045 | 0.818 | 0.138 | 0.557 | 0.110 |
| Mono-Mono | 0.939 | 0.149 | 0.702 | 0.133 | 0.155 | 0.063 | 0.966 | 0.150 | 0.691 | 0.124 |
| Right-Left | 3.728 | 0.241 | 1.915 | 0.187 | 0.375 | 0.073 | 3.068 | 0.218 | 2.272 | 0.180 |
| M2B w/retrieved image | 0.872 | 0.168 | 0.644 | 0.131 | 0.145 | 0.058 | 0.873 | 0.143 | 0.634 | 0.125 |
| P2B w/retrieved image | 0.661 | 0.139 | 0.920 | 0.131 | 0.135 | 0.058 | 0.822 | 0.138 | 0.635 | 0.117 |
| Ours | 0.638 | 0.121 | 0.635 | 0.124 | 0.123 | 0.053 | 0.865 | 0.141 | 0.565 | 0.110 |

Table 1 shows the quantitative results of AV-NeRF on four scenes. The AV-NeRF model was compared with other methods of binaural audio generation. The original method MONO2BINAURAL (M2B) and a recently proposed method PSEUDO2BINAURAL (P2B) were selected for comparison. Mono-Mono and Right-Left were also used as two baseline methods. Mono-Mono copies the input mixed audio twice to generate fake binaural audio and Right-Left switches two channels to generate binaural audio. Right-Left was used as the upper bound of STFT and ENV distance. There is no surprise that the AV-NeRF model does not surpass M2B and P2B because these two models are trained on the entire dataset with nearly 1,500 training samples and the visual encoder is pre-trained on ImageNet, while the AV-NeRF model is trained on less than 10 samples per scene from scratch. Even with much less training data, the AV-NeRF model achieves competitive results to M2B and P2B. M2B and P2B models rely on ground-truth images for audio spatialization. However, the AV-NeRF model does not have access to ground-truth images. For a fair comparison, M2B and P2B were adapted to generate audio at novel poses. Instead of feeding M2B and P2B with ground-truth images, they were input with retrieved images with the nearest camera poses. After the absence of ground-truth images, their models have a clear performance degradation and fall behind AV-NeRF. Accordingly, AV-NeRF outperforms M2B and P2B with distinct advantages.

TABLE 2
Ablation study on different components of AV-NeRF.

| | Harp | | Cello | | Drum | | Guitar | |
|---|---|---|---|---|---|---|---|---|
| Methods | STFT | ENV | STFT | ENV | STFT | ENV | STFT | ENV |
| Baseline | 0.702 | 0.135 | 0.776 | 0.130 | 0.154 | 0.063 | 0.877 | 0.138 |
| w/AVB | 0.635 | 0.129 | 0.642 | 0.126 | 0.149 | 0.060 | 0.877 | 0.141 |
| w/AVB & CT | 0.638 | 0.121 | 0.635 | 0.124 | 0.123 | 0.053 | 0.865 | 0.141 |

Ablation studies were conducted on FAIR-PLAY to further validate the proposed pipeline. AV-NeRF was decomposed into the baseline model, AV-Bridge, and coordinate transformation module. As shown in Table 2, adding AV-Bridge and coordinate transformation module to AV-NeRF can boost its performance.

In this work, a first-of-its-kind AV-NeRF system that is capable of synthesizing real-world audio-visual scenes accompanied by binaural audio is proposed. The AV-NeRF model can generate audio with rich spatial information at novel camera poses. The effectiveness of the disclosed method on FAIR-PLAY and real-world indoor scenes is thus demonstrated.

There is a range of promising future directions. First, the disclosed AV-NeRF method learns and models the spatial audio effects caused by distance and orientation. The reverberation that exists in environments is not modeled. The present work may be extended to further address sound propagation. Second, static scenes with a fixed sound source are focused on in the present disclosure. However, there could be multiple sounding objects in a single environment, and these sound sources may move. How to learn implicit neural representations for audio-visual scenes with multiple dynamic sound sources is still an open question. Third, there are power audio-visual simulation platforms (e.g., SOUNDSPACES 2.0) that can render realistic audio and visual scenes in virtual environments. An interesting direction is to explore how to integrate the AV-NeRF with virtual simulation to strengthen learning robustness and generalization ability.

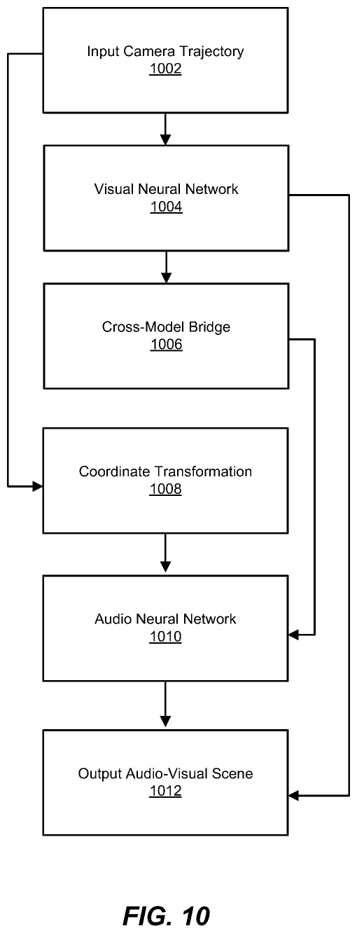

FIG. 10 is a flow diagram of an exemplary audio-visual scene synthesis method in accordance with embodiments of this disclosure. As illustrated in FIG. 10, a novel (arbitrary) input camera trajectory 1002 may be received by a visual neural network at step 1004 as shown. The visual neural network may generate a sequence of frames in accordance with the input camera trajectory, with the generated frames included at step 1012 as part of the synthesized output audio-visual scene for the input camera trajectory. The visual neural network may also generate geometric information that is input to the illustrated cross-model bridge at step 1006. In various examples, coordinates for the input camera trajectory may be determined by a coordinate transformation module at step 1008, as illustrated. As further shown in FIG. 10, an audio neural network may receive two signals at step 1010: 1) a modified camera trajectory from the coordinate transformation module and 2) model parameters (acoustic embeddings) from the cross-model bridge. The audio neural network may utilize the received signals to synthesize a sequence of multi-channel (e.g., two-channel) audio. The coordinate transformation module may, e.g., receive the input camera pose, apply a transformation to the camera direction, and generate the new camera direction that is expressed relative to the sound source. Additionally, the cross-model bridge network may, for example, analyze the 3D environment modeled by the visual neural network and generate the parameters of the audio neural network. The two-channel audio generated by the audio neural network may then be combined with the sequence of video frames generated by the visual neural network to output a novel synthesized audio-visual scene at step 1012 corresponding to the novel input camera trajectory.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1100 in FIG. 11) or that visually immerses a user in an artificial reality (such as, e.g., virtual-reality system 1200 in FIG. 12). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 11, augmented-reality system 1100 may include an eyewear device 1102 with a frame 1110 configured to hold a left display device 1115(A) and a right display device 1115(B) in front of a user's eyes. Display devices 1115(A) and 1115(B) may act together or independently to present an image or series of images to a user. While augmented-reality system 1100 includes two displays, embodiments of this disclosure may be implemented in augmented-reality systems with a single NED or more than two NEDs.

In some embodiments, augmented-reality system 1100 may include one or more sensors, such as sensor 1140. Sensor 1140 may generate measurement signals in response to motion of augmented-reality system 1100 and may be located on substantially any portion of frame 1110. Sensor 1140 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1100 may or may not include sensor 1140 or may include more than one sensor. In embodiments in which sensor 1140 includes an IMU, the IMU may generate calibration data based on measurement signals from sensor 1140. Examples of sensor 1140 may include, without limitation, accelerometers, gyroscopes, magnetometers, other suitable types of sensors that detect motion, sensors used for error correction of the IMU, or some combination thereof.

In some examples, augmented-reality system 1100 may also include a microphone array with a plurality of acoustic transducers 1120(A)-1120(J), referred to collectively as acoustic transducers 1120. Acoustic transducers 1120 may represent transducers that detect air pressure variations induced by sound waves. Each acoustic transducer 1120 may be configured to detect sound and convert the detected sound into an electronic format (e.g., an analog or digital format). The microphone array in FIG. 11 may include, for example, ten acoustic transducers: 1120(A) and 1120(B), which may be designed to be placed inside a corresponding ear of the user, acoustic transducers 1120(C), 1120(D), 1120(E), 1120(F), 1120(G), and 1120(H), which may be positioned at various locations on frame 1110, and/or acoustic transducers 1120(1) and 1120(J), which may be positioned on a corresponding neckband 1105.

In some embodiments, one or more of acoustic transducers 1120(A)-(J) may be used as output transducers (e.g., speakers). For example, acoustic transducers 1120(A) and/or 1120(B) may be earbuds or any other suitable type of headphone or speaker.

The configuration of acoustic transducers 1120 of the microphone array may vary. While augmented-reality system 1100 is shown in FIG. 11 as having ten acoustic transducers 1120, the number of acoustic transducers 1120 may be greater or less than ten. In some embodiments, using higher numbers of acoustic transducers 1120 may increase the amount of audio information collected and/or the sensitivity and accuracy of the audio information. In contrast, using a lower number of acoustic transducers 1120 may decrease the computing power required by an associated controller 1150 to process the collected audio information. In addition, the position of each acoustic transducer 1120 of the microphone array may vary. For example, the position of an acoustic transducer 1120 may include a defined position on the user, a defined coordinate on frame 1110, an orientation associated with each acoustic transducer 1120, or some combination thereof.

Acoustic transducers 1120(A) and 1120(B) may be positioned on different parts of the user's ear, such as behind the pinna, behind the tragus, and/or within the auricle or fossa. Or, there may be additional acoustic transducers 1120 on or surrounding the ear in addition to acoustic transducers 1120 inside the ear canal. Having an acoustic transducer 1120 positioned next to an ear canal of a user may enable the microphone array to collect information on how sounds arrive at the ear canal. By positioning at least two of acoustic transducers 1120 on either side of a user's head (e.g., as binaural microphones), augmented-reality device 1100 may simulate binaural hearing and capture a 3D stereo sound field around about a user's head. In some embodiments, acoustic transducers 1120(A) and 1120(B) may be connected to augmented-reality system 1100 via a wired connection 1130, and in other embodiments acoustic transducers 1120(A) and 1120(B) may be connected to augmented-reality system 1100 via a wireless connection (e.g., a BLUETOOTH connection). In still other embodiments, acoustic transducers 1120(A) and 1120(B) may not be used at all in conjunction with augmented-reality system 1100.

Acoustic transducers 1120 on frame 1110 may be positioned in a variety of different ways, including along the length of the temples, across the bridge, above or below display devices 1115(A) and 1115(B), or some combination thereof. Acoustic transducers 1120 may also be oriented such that the microphone array is able to detect sounds in a wide range of directions surrounding the user wearing the augmented-reality system 1100. In some embodiments, an optimization process may be performed during manufacturing of augmented-reality system 1100 to determine relative positioning of each acoustic transducer 1120 in the microphone array.

In some examples, augmented-reality system 1100 may include or be connected to an external device (e.g., a paired device), such as neckband 1105. Neckband 1105 generally represents any type or form of paired device. Thus, the following discussion of neckband 1105 may also apply to various other paired devices, such as charging cases, smart watches, smart phones, wrist bands, other wearable devices, hand-held controllers, tablet computers, laptop computers, other external compute devices, etc.

As shown, neckband 1105 may be coupled to eyewear device 1102 via one or more connectors. The connectors may be wired or wireless and may include electrical and/or non-electrical (e.g., structural) components. In some cases, eyewear device 1102 and neckband 1105 may operate independently without any wired or wireless connection between them. While FIG. 11 illustrates the components of eyewear device 1102 and neckband 1105 in example locations on eyewear device 1102 and neckband 1105, the components may be located elsewhere and/or distributed differently on eyewear device 1102 and/or neckband 1105. In some embodiments, the components of eyewear device 1102 and neckband 1105 may be located on one or more additional peripheral devices paired with eyewear device 1102, neckband 1105, or some combination thereof.

Pairing external devices, such as neckband 1105, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1100 may be provided by a paired device or shared between a paired device and an eyewear device, thus reducing the weight, heat profile, and form factor of the eyewear device overall while still retaining desired functionality. For example, neckband 1105 may allow components that would otherwise be included on an eyewear device to be included in neckband 1105 since users may tolerate a heavier weight load on their shoulders than they would tolerate on their heads. Neckband 1105 may also have a larger surface area over which to diffuse and disperse heat to the ambient environment. Thus, neckband 1105 may allow for greater battery and computation capacity than might otherwise have been possible on a stand-alone eyewear device. Since weight carried in neckband 1105 may be less invasive to a user than weight carried in eyewear device 1102, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1105 may be communicatively coupled with eyewear device 1102 and/or to other devices. These other devices may provide certain functions (e.g., tracking, localizing, depth mapping, processing, storage, etc.) to augmented-reality system 1100. In the embodiment of FIG. 11, neckband 1105 may include two acoustic transducers (e.g., 1120(l) and 1120(J)) that are part of the microphone array (or potentially form their own microphone subarray). Neckband 1105 may also include a controller 1125 and a power source 1135.

Acoustic transducers 1120(l) and 1120(J) of neckband 1105 may be configured to detect sound and convert the detected sound into an electronic format (analog or digital). In the embodiment of FIG. 11, acoustic transducers 1120(l) and 1120(J) may be positioned on neckband 1105, thereby increasing the distance between the neckband acoustic transducers 1120(1) and 1120(J) and other acoustic transducers 1120 positioned on eyewear device 1102. In some cases, increasing the distance between acoustic transducers 1120 of the microphone array may improve the accuracy of beamforming performed via the microphone array. For example, if a sound is detected by acoustic transducers 1120(C) and 1120(D) and the distance between acoustic transducers 1120(C) and 1120(D) is greater than, e.g., the distance between acoustic transducers 1120(D) and 1120(E), the determined source location of the detected sound may be more accurate than if the sound had been detected by acoustic transducers 1120(D) and 1120(E).

Controller 1125 of neckband 1105 may process information generated by the sensors on neckband 1105 and/or augmented-reality system 1100. For example, controller 1125 may process information from the microphone array that describes sounds detected by the microphone array. For each detected sound, controller 1125 may perform a direction-of-arrival (DOA) estimation to estimate a direction from which the detected sound arrived at the microphone array. As the microphone array detects sounds, controller 1125 may populate an audio data set with the information. In embodiments in which augmented-reality system 1100 includes an inertial measurement unit, controller 1125 may compute all inertial and spatial calculations from the IMU located on eyewear device 1102. A connector may convey information between augmented-reality system 1100 and neckband 1105 and between augmented-reality system 1100 and controller 1125. The information may be in the form of optical data, electrical data, wireless data, or any other transmittable data form. Moving the processing of information generated by augmented-reality system 1100 to neckband 1105 may reduce weight and heat in eyewear device 1102, making it more comfortable to the user.

Power source 1135 in neckband 1105 may provide power to eyewear device 1102 and/or to neckband 1105. Power source 1135 may include, without limitation, lithium ion batteries, lithium-polymer batteries, primary lithium batteries, alkaline batteries, or any other form of power storage. In some cases, power source 1135 may be a wired power source. Including power source 1135 on neckband 1105 instead of on eyewear device 1102 may help better distribute the weight and heat generated by power source 1135.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1200 in FIG. 12, that mostly or completely covers a user's field of view. Virtual-reality system 1200 may include a front rigid body 1202 and a band 1204 shaped to fit around a user's head. Virtual-reality system 1200 may also include output audio transducers 1206(A) and 1206(B). Furthermore, while not shown in FIG. 12, front rigid body 1202 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1100 and/or virtual-reality system 1200 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1100 and/or virtual-reality system 1200 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1100 and/or virtual-reality system 1200 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

### EXAMPLE EMBODIMENTS

Example 1: A scene synthesis system may include (i) a visual neural network, (ii) a cross-model bridge, and (iii) an audio neural network, where parameters of the audio neural network are generated by the cross-model bridge based on analysis of a three-dimensional visual environment modeled by the visual neural network.
Example 2: The scene synthesis system of example 1 may further include a coordinate transformation module that applies a transformation to an input camera direction to synthesize a new camera direction.
Example 3: The scene synthesis system of examples 1-2, where the audio neural network utilizes the new camera direction and the parameters of the audio neural network to synthesize a multi-channel audio signal corresponding to the new camera direction.
Example 4: The scene synthesis system of examples 1-3, where the visual neural network receives an input camera trajectory and generates a sequence of visual frames to model the three-dimensional visual environment.
Example 5: The scene synthesis system of examples 1-4, where the visual neural network generates geometric information that is input to the cross-model bridge.
Example 6: The scene synthesis system of examples 1-5, where the visual neural network encodes the geometric information into a feature vector for acoustic-aware audio generation.
Example 7: The scene synthesis system of examples 1-6 may further include a convolutional neural network that extracts the geometric information.
Example 8: The scene synthesis system of examples 1-7, where the cross-model bridge includes a neural network configured to analyze the three-dimensional environment modeled by the visual neural network and generate the parameters of the audio neural network.
Example 9: The scene synthesis system of examples 1-8, where the parameters of the audio neural network generated by the cross-model bridge includes acoustic embeddings.
Example 10: A method for scene synthesis may include (i) receiving, at a visual neural network, input images captured by a camera at an input trajectory, (ii) modeling, at the visual neural network, a three-dimensional visual environment, and (iii) generating, at a cross-model bridge, parameters of an audio neural network based on analysis of the three-dimensional visual environment.
Example 11: The method of example 10 may further include synthesizing, at a coordinate transformation module, a new camera direction.
Example 12: The method of examples 10-11 may further include synthesizing, at the audio neural network, a multi-channel audio signal corresponding to the new camera direction.
Example 13: The method of examples 10-12, where the visual neural network receives an input camera trajectory and generates a sequence of visual frames to model the three-dimensional visual environment.
Example 14: The method of examples 10-13, where the visual neural network generates geometric information that is input to the cross-model bridge.
Example 15: The method of examples 10-14, where the visual neural network encodes the geometric information into a feature vector for acoustic-aware audio generation.
Example 16: The method of examples 10-15, where generating, at the cross-model bridge, the parameters of an audio neural network includes extracting the geometric information via a convolutional neural network.
Example 17: The method of examples 10-16, where the cross-model bridge includes a neural network configured to analyze the three-dimensional environment modeled by the visual neural network and generate the parameters of the audio neural network.
Example 18: The method of examples 10-17, where the parameters of the audio neural network generated by the cross-model bridge includes acoustic embeddings.
Example 19: A non-transitory computer-readable medium may include one or more computer-readable instructions that, when executed by at least one processor of a computing device, cause the computing device to (i) receive, at a visual neural network, input images captured by a camera at an input trajectory, (ii) model, at the visual neural network, a three-dimensional visual environment, and (iii) generate, at a cross-model bridge, parameters of an audio neural network based on analysis of the three-dimensional visual environment.
Example 20: The non-transitory computer-readable medium of example 19, where the computer-readable instructions cause the computing device to synthesize, at a coordinate transformation module, a new camera direction.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A scene synthesis system, comprising:
a visual neural network;
a cross-model bridge; and
an audio neural network, wherein parameters of the audio neural network are generated by the cross-model bridge based on analysis of a three-dimensional visual environment modeled by the visual neural network.

2. The scene synthesis system of claim 1, further comprising a coordinate transformation module that applies a transformation to an input camera direction to synthesize a new camera direction.

3. The scene synthesis system of claim 2, wherein the audio neural network utilizes the new camera direction and the parameters of the audio neural network to synthesize a multi-channel audio signal corresponding to the new camera direction.

4. The scene synthesis system of claim 1, wherein the visual neural network receives an input camera trajectory and generates a sequence of visual frames to model the three-dimensional visual environment.

5. The scene synthesis system of claim 1, wherein the visual neural network generates geometric information that is input to the cross-model bridge.

6. The scene synthesis system of claim 5, wherein the visual neural network encodes the geometric information into a feature vector for acoustic-aware audio generation.

7. The scene synthesis system of claim 5, further comprising a convolutional neural network that extracts the geometric information.

8. The scene synthesis system of claim 1, wherein the cross-model bridge comprises a neural network configured to analyze the three-dimensional environment modeled by the visual neural network and generate the parameters of the audio neural network.

9. The scene synthesis system of claim 1, wherein the parameters of the audio neural network generated by the cross-model bridge comprise acoustic embeddings.

10. A method, comprising:
receiving, at a visual neural network, input images captured by a camera at an input trajectory;
modeling, at the visual neural network, a three-dimensional visual environment; and
generating, at a cross-model bridge, parameters of an audio neural network based on analysis of the three-dimensional visual environment.

11. The method of claim 10, further comprising synthesizing, at a coordinate transformation module, a new camera direction.

12. The method of claim 11, further comprising synthesizing, at the audio neural network, a multi-channel audio signal corresponding to the new camera direction.

13. The method of claim 10, wherein the visual neural network receives an input camera trajectory and generates a sequence of visual frames to model the three-dimensional visual environment.

14. The method of claim 10, wherein the visual neural network generates geometric information that is input to the cross-model bridge.

15. The method of claim 14, wherein the visual neural network encodes the geometric information into a feature vector for acoustic-aware audio generation.

16. The method of claim 14, wherein generating, at the cross-model bridge, the parameters of the audio neural network, comprises extracting the geometric information via a convolutional neural network.

17. The method of claim 10, wherein the cross-model bridge comprises a neural network configured to analyze the three-dimensional environment modeled by the visual neural network and generate the parameters of the audio neural network.

18. The method of claim 10, wherein the parameters of the audio neural network generated by the cross-model bridge comprise acoustic embeddings.

19. A non-transitory computer-readable medium comprising one or more computer-readable instructions that, when executed by at least one processor of a computing device, cause the computing device to:
receive, at a visual neural network, input images captured by a camera at an input trajectory;
model, at the visual neural network, a three-dimensional visual environment; and
generate, at a cross-model bridge, parameters of an audio neural network based on analysis of the three-dimensional visual environment.

20. The non-transitory computer-readable medium of claim 19, wherein the computer-readable instructions cause the computing device to synthesize, at a coordinate transformation module, a new camera direction.
